(19) United States
(12) Patent Application Publication
(10) Pub. No.: US 2022/0365741 A1
(43) Pub. Date: Nov. 17, 2022

(54) INFORMATION TERMINAL SYSTEM, METHOD, AND STORAGE MEDIUM

(71) Applicant: CANON KABUSHIKI KAISHA, Tokyo (JP)

(72) Inventors: Naoto Yuki, Kanagawa (JP); Shinsaku Kanamori, Kanagawa (JP); Tomoya Otani, Tokyo (JP)

(21) Appl. No.: 17/738,953

(22) Filed: May 6, 2022

(30) Foreign Application Priority Data
May 14, 2021 (JP) 2021-082213

(51) Int. Cl. G06F 3/14; G06F 3/01

(52) U.S. Cl. CPC G06F 3/1454; G06F 3/017; G06F 3/013

(57) ABSTRACT

An information terminal system includes a mobile terminal having a display and a glasses-type wearable terminal being communicably connected to each other. The glasses-type wearable terminal includes a display unit configured to display an operable extended screen by projecting the extended screen in a view of a user based on display information of the extended screen received from the mobile terminal, a first detection unit configured to detect a user operation, and a first transmission unit configured to transmit information indicating the user operation to the mobile terminal. The mobile terminal includes a second transmission unit configured to transmit the display information of the extended screen to the glasses-type wearable terminal, and a processing unit configured to execute processing corresponding to the user operation based on the received information indicating the user operation.

### BACKGROUND

### Field

The present disclosure relates to an information terminal system consisting of a glasses-type wearable terminal capable of communicating with a mobile terminal such as a smartphone, a control method for the information terminal system, and a storage medium.

### Description of the Related Art

In recent years, one type of wearable terminal is a glasses-type wearable terminal called a smart glass, a head mounted display (HMD), or the like. There is also a glasses-type wearable terminal that has a function of providing a video image to a field of view of a human via glasses, such as virtual reality (VR) or AR, in addition to a communication function. Further, there is discussed a technique where a user operates an extended screen displayed by AR or the like, and the user overlaps a physical device having a touch panel with the extended screen (Japanese Patent No. 6346585).

Another technique is provided for displaying information whose size is greater than or equal to a size that can be displayed on a smartphone as an extended screen by AR, by interlocking a mobile terminal having a display, such as a smartphone, with a glasses-type wearable terminal. In this way, the screen provided by the smartphone can be extended using AR or the like and provided to the user.

However, in the technique discussed in Japanese Patent No. 6346585, in order to operate the screen displayed via the glasses-type wearable terminal as the screen extended from the screen provided by the mobile terminal such as the smartphone, the physical device separate from the smartphone is necessary.

In the technique described above as another conventional technique, although the user can view the information whose size is greater than or equal to the size that can be displayed on the display of the smartphone on the screen extended by AR, there is an issue that the user cannot operate the extended screen.

### SUMMARY OF THE INVENTION

The present disclosure particularly relates to display of information exceeding a display size of the smartphone on an extended screen whose position is adjusted to the position of the smartphone using augmented reality (AR) of the glasses-type wearable terminal. The present disclosure also relates to detection of a user operation on the extended screen employing AR, notification of the user operation to the smartphone, and re-rendering of the extended screen based on a response from the smartphone, by the glasses-type wearable terminal.

The present disclosure is directed to providing an information terminal system that consists of a glasses-type information terminal capable of communicating with a mobile terminal, and enables a user operation on an extended screen displayed outside a display of the mobile terminal.

According to an aspect of the present disclosure, an information terminal system includes a mobile terminal having a display and a glasses-type wearable terminal being communicably connected to each other, the glasses-type wearable terminal including at least one processor and at least a memory having instructions stored thereon, and when executed by the at least one processor, acting as a display unit configured to display an operable extended screen by projecting the extended screen in part of a view of a user wearing the glasses-type wearable terminal based on display information of the extended screen received from the mobile terminal, a first detection unit configured to detect a user operation on the extended screen, and a first transmission unit configured to transmit information indicating the user operation detected by the first detection unit to the mobile terminal, the mobile terminal including at least one processor and at least a memory having instructions stored thereon, and when executed by the at least one processor, acting as a second transmission unit configured to transmit the display information of the extended screen to the glasses-type wearable terminal, and a processing unit configured to execute processing corresponding to the user operation based on the information indicating the user operation transmitted by the first transmission unit.

Further features of the present disclosure will become apparent from the following description of exemplary embodiments with reference to the attached drawings.

### BRIEF DESCRIPTION OF THE DRAWINGS

FIG. 1 is an overview diagram of an information terminal system (including a glasses-type wearable terminal and a smartphone).

FIG. 2A is a block diagram illustrating a hardware configuration of the glasses-type wearable terminal.

FIG. 2B is a block diagram illustrating a hardware configuration of the smartphone.

FIG. 3A is a block diagram illustrating a software configuration of the glasses-type wearable terminal.

FIG. 3B is a block diagram illustrating a software configuration of the smartphone.

FIGS. 4A, 4B, and 4C illustrate display examples of an extended screen (not displayed, displayed, and after an operation).

FIG. 5 illustrates a display example of an extended screen setting screen displayed on the smartphone.

FIG. 6 illustrates a processing procedure of determination as to whether a user is gazing at the smartphone.

FIG. 7 illustrates a sequence diagram related to displaying and operating the extended screen on the glasses-type wearable terminal.

FIG. 8 illustrates a processing procedure when a screen operation is performed on or a notification event is received by the smartphone.

FIG. 9 illustrates a processing procedure when a user operation detection event is received by the smartphone.

FIG. 10 illustrates a processing procedure when an extended screen display request is received by the glasses-type wearable terminal.

FIG. 11 illustrates a connection relationship between the glasses-type wearable terminal and the smartphone according to another exemplary embodiment.

FIG. 12 is a diagram illustrating detection of a user operation using an infrared screen according to the other exemplary embodiment.

### DESCRIPTION OF THE EMBODIMENTS

Exemplary embodiments of the present disclosure will be described below with reference to the drawings.

The following exemplary embodiments are not intended to limit the invention set forth in the claims, and not all the combinations of features described in the exemplary embodiments are necessarily indispensable to the solution of the invention.

A first exemplary embodiment of the present invention will be described below with reference to the drawings.

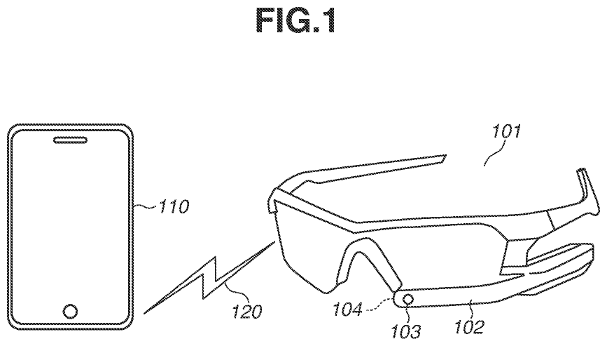

FIG. 1 illustrates an overview of an information terminal system in which a glasses-type wearable terminal 101 and a smartphone 110 serving as a mobile terminal are communicatively connected to each other.

The glasses-type wearable terminal 101 is a wearable information terminal to be worn by a user, and includes a display unit 102 that displays a video image which is a virtual image within the view of the user without blocking the user's view. Such display is called augmented reality (AR) or mixed reality (MR), and provided by a function of projecting information on a transmissive display (lens) or directly on retinas. In the present exemplary embodiment, a screen formed by projecting information on the display unit 102 of the glasses-type wearable terminal 101 will be referred to as an extended screen.

The display unit 102 is provided with an outward sensor unit 103 facing in a direction of the line of sight of the user, and an inward sensor unit 104 facing in a direction opposite thereto. In the outward sensor unit 103, a LiDAR sensor can measure the distance to an object and the shape of the object, an infrared sensor can measure the temperature of the object, and an image sensor can perform processing such as image processing and feature recognition processing for the object. In the inward sensor unit 104, a near-infrared sensor and an image sensor can perform eye tracking that tracks and analyzes the movement of the line of sight of the user. The inward sensor unit 104 may be configured to detect a blink (the movement of an eyelid) of the user.

The glasses-type wearable terminal 101 and the smartphone 110 can exchange data via wireless communication 120. In the present exemplary embodiment, wireless communication compliant with a standard such as Bluetooth® or near field communication (NFC) is used, but the communication 120 is not limited thereto, and other wireless communication techniques such as Wi-Fi® may be used if the glasses-type wearable terminal 101 and the smartphone 110 can communicate with each other.

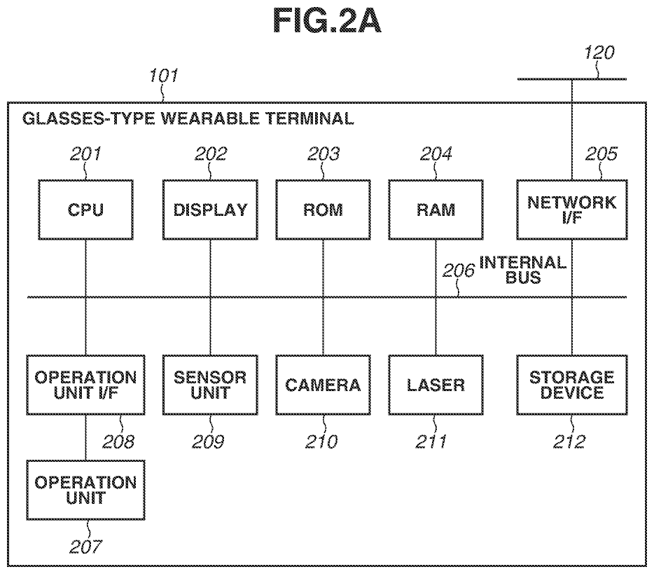

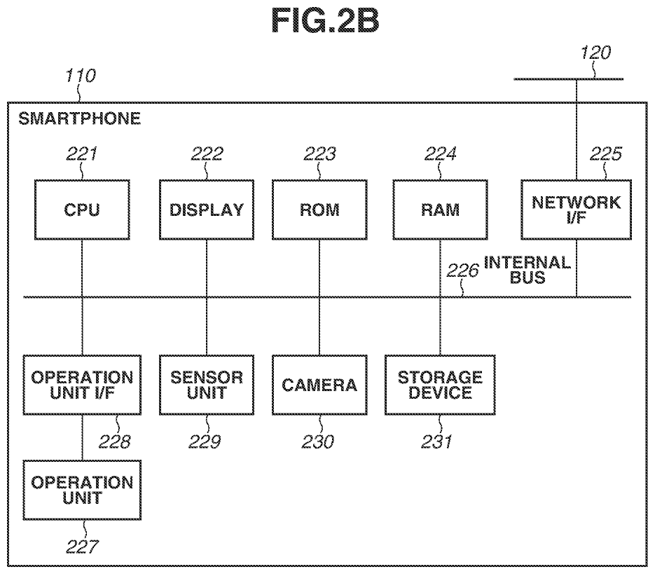

FIG. 2A is a diagram illustrating a hardware configuration of the glasses-type wearable terminal 101 according to an exemplary embodiment of the present invention. A central processing unit (CPU) 201 comprehensively controls various functions of the glasses-type wearable terminal 101 via an internal bus 206, by executing an application program stored in a read only memory (ROM) 203. A display 202 displays a result of the execution of the application program by the CPU 201. The display 202 corresponds to the display unit 102 in FIG. 1. In the present exemplary embodiment, a method in which a user looks at an image projected on a transmissive display is used, but a method of direct projection on retinas can also be adopted. The ROM 203 is a nonvolatile memory such as a flash memory, and stores various kinds of setting information, the application program described above, and the like. A random access memory (RAM) 204 functions as a memory and a work area of the CPU 201. A network interface (I/F) 205 enables the glasses-type wearable terminal 101 to communicate with an external network device via the wireless communication 120, and controls one-way or two-way exchange of data. An operation unit 207 accepts an input from the user at a frame, and transmits a signal corresponding to the input to each of the above-described processing units using an operation unit I/F 208. A sensor unit 209 includes, in addition to the outward sensor unit 103 and the inward sensor unit 104, a global positioning system (GPS) sensor, a gyro sensor, an acceleration sensor, a proximity sensor, and a blood pressure and heart rate measurement sensor. A camera 210 has an image capturing function, and captured-image data is stored in the ROM 203. A laser 211 projects various contents on the display 202, and projects the contents directly on retinas in the case of the retina projection method. A storage device 212 is a storage medium, and stores various data such as an application. Further, the storage device 212 includes a device for reading data on a storage medium, and a device for deleting data. There is a case where the storage device 212 is not provided and only the ROM 203 is provided, depending on the glasses-type wearable terminal 101.

FIG. 2B is a diagram illustrating a configuration of the smartphone 110 according to an exemplary embodiment of the present invention. A CPU 221 comprehensively controls various functions of the smartphone 110 via an internal bus 226, by executing an application program stored in a ROM 223. A display 222 displays a result of the application program by the CPU 221. The ROM 223 is a nonvolatile memory such as a flash memory, and stores various kinds of setting information, the application program described above, and the like. A RAM 224 functions as a memory and a work area of the CPU 221. A network I/F 225 enables the smartphone 110 to communicate with an external network device via the wireless communication 120, and controls one-way or two-way exchange of data. An operation unit 227 accepts an input from the user at the display 222, and transmits a signal corresponding to the input to each of the above-described processing units using an operation unit I/F 228. A sensor unit 229 includes a GPS sensor, a gyro sensor, and an acceleration sensor. A camera 230 has an image capturing function, and captured-image data is stored in the ROM 223. A storage device 231 is a storage medium, and stores various data such as an application. Further, the storage device 231 includes a device for reading data on a storage medium, and a device for deleting data.

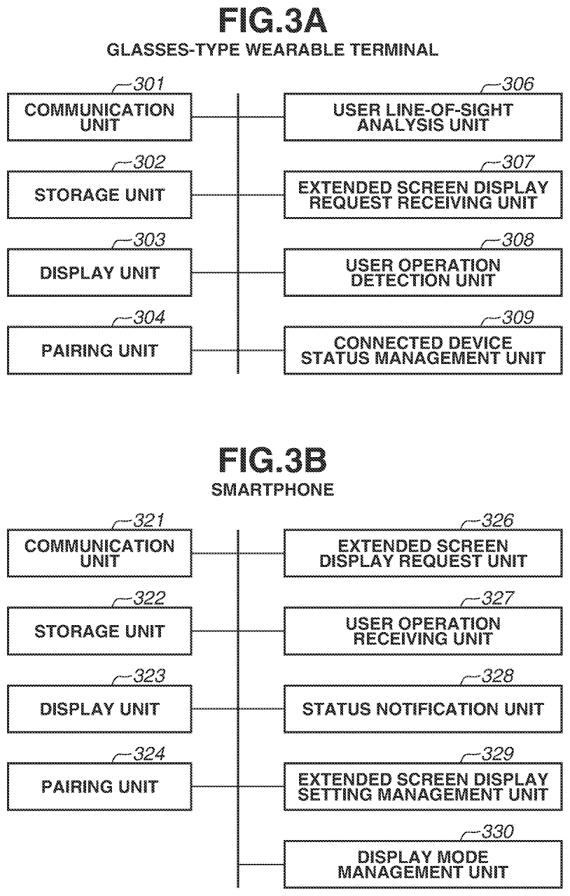

FIG. 3A is a diagram illustrating a software module configuration of the glasses-type wearable terminal 101. The CPU 201 of the glasses-type wearable terminal 101 executes a program stored in the ROM 203 or the like, so that each unit illustrated in FIG. 3A is implemented.

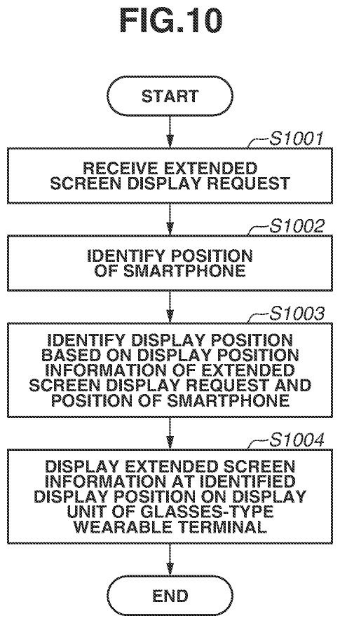

A communication unit 301 transmits and receives notifications to and from the smartphone 110 via the wireless communication 120. A storage unit 302 exchanges information with the ROM 203, the RAM 204, and other processing units. A display unit 303 displays contents (projects information) on the display 202 so that virtual contents are superimposed on a real space, using an AR technology. In other words, the display unit 303 projects information in part of the view of the user wearing the glasses-type wearable terminal 101. A pairing unit 304 controls the network I/F 205 so that two-way data communication with an external network device can be performed via the wireless communication 120. A user line-of-sight analysis unit 306 tracks and analyzes the movement of the line of sight of the user wearing the glasses-type wearable terminal 101, using the near-infrared sensor and the image sensor of the inward sensor unit 104. An extended screen display request receiving unit 307 receives, from the communication unit 301, an extended screen display request, which is the display information of the extended screen from the smartphone 110. The extended screen display request includes extended screen information to be displayed on the display unit 102, and display position information about a display position. Based on the extended screen display request received by the extended screen display request receiving unit 307, the display unit 303 displays the extended screen on the display 202. The details will be described below with reference to FIG. 10. A user operation detection unit 308 detects an operation performed by the user wearing the glasses-type wearable terminal 101, using the outward sensor unit 103. A connected device status management unit 309 manages the state of the smartphone 110 paired by the pairing unit 304. The connected device status management unit 309 receives the state of the smartphone 110 from the smartphone 110 via the communication unit 301. The state of the smartphone 110 is any one of three states, which are “Power Off” that is a state where the power is off, “Locked State” in which the power is on and the smartphone 110 is locked, and “Unlocked State” in which the power is on and the smartphone 110 is unlocked.

FIG. 3B is a diagram illustrating a software module configuration of the smartphone 110. The CPU 221 of the smartphone 110 executes a program stored in the ROM 223 or the like, so that each unit illustrated in FIG. 3B is implemented.

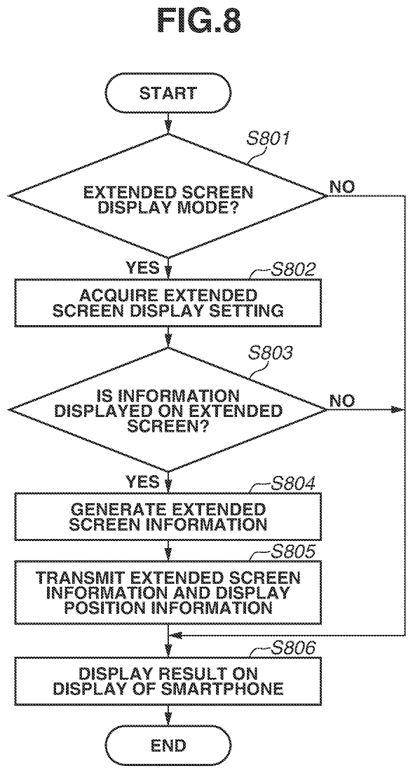

A communication unit 321 transmits and receives notifications to and from the glasses-type wearable terminal 101 via the wireless communication 120. A storage unit 322 exchanges information with the ROM 223, the RAM 224, and other processing units. A display unit 323 displays contents on the display 222. A pairing unit 324 controls the network I/F 225 so that two-way data communication with an external network device can be performed via the wireless communication 120. An extended screen display request unit 326 transmits the extended screen display request, which is the display information of the extended screen, to the glasses-type wearable terminal 101 via the communication unit 321. The extended screen display request unit 326 transmits the extended screen display request based on information of an extended screen display setting management unit 329 to be described below when a user operation or an event such as a notification is detected by the smartphone 110. The details will be described below with reference to FIG. 8.

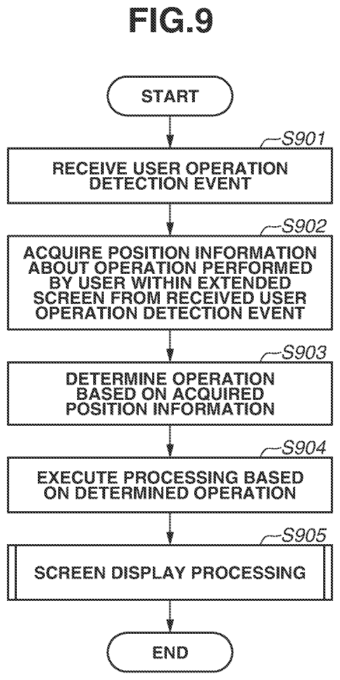

A user operation receiving unit 327 receives a user operation detected by the glasses-type wearable terminal 101. The details will be described below with reference to FIG. 9. A status notification unit 328 notifies the state of the smartphone 110 to the glasses-type wearable terminal 101 paired by the pairing unit 304, via the communication unit 321. The extended screen display setting management unit 329 stores the display of a screen for setting contents to be displayed as the extended screen and the position information, and the set contents, in the storage unit 322, as extended screen setting information. The above-described extended screen is a screen displayed on the display unit 102 of the glasses-type wearable terminal 101, which is a screen displayed as an extension of a screen displayed on the display 222 of the smartphone 110, and can be operated.

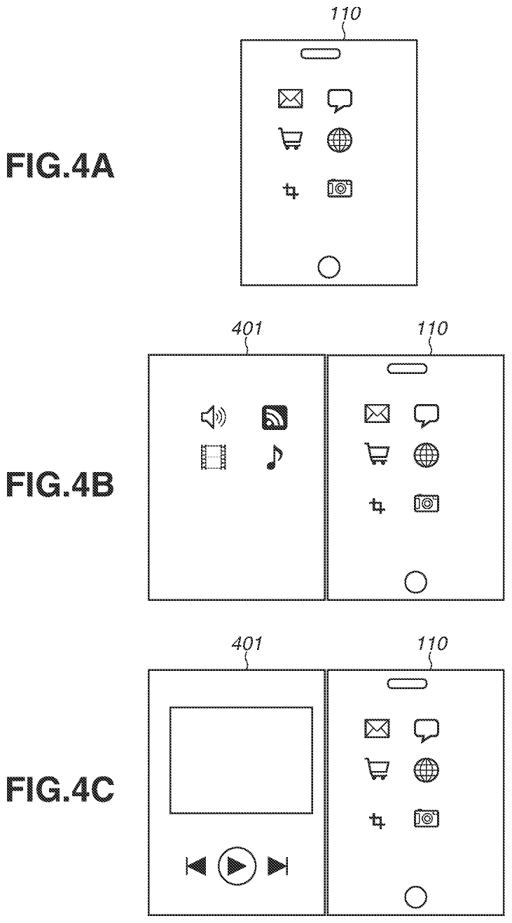

For example, a home screen is displayed on the smartphone 110, usually, in a manner illustrated in FIG. 4A.

As illustrated in FIG. 4B, an icon for an application that cannot be displayed on the display 222 of the smartphone 110 is displayed on the display unit 102 of the glasses-type wearable terminal 101, as an extended screen 401, by using AR. It is possible to provide the user with more information by displaying the extended screen 401 in this manner.

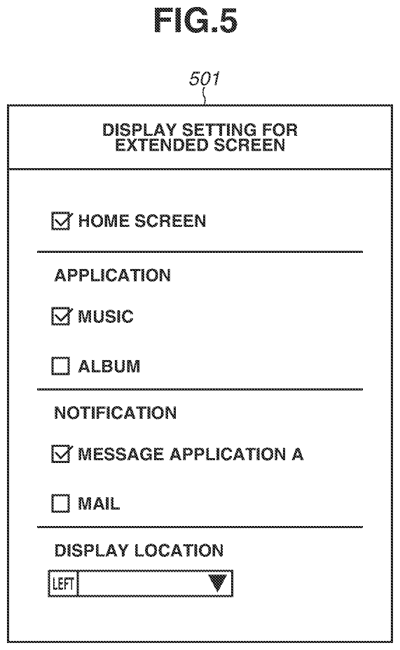

The extended screen display setting management unit 329 manages setting information for the extended screen. The user sets the extended screen via an extended screen setting screen 501 (FIG. 5) displayed on the display 222 of the smartphone 110 by the extended screen display setting management unit 329.

Here, the extended screen setting screen 501 illustrated in FIG. 5 will be described. Applications displayed on the extended screen setting screen 501 are only applications that are displayable on the extended screen 401. In the example in FIG. 5, a check box for each of “Home Screen”, “Music”, and “Message Application A” is checked. This indicates such a setting that, when the home screen is opened, when the music application is opened, or when a notification from the Message Application A is received, the corresponding content is displayed on the extended screen 401. Specifically, in a case where an operation for opening the music application is performed on the extended screen 401 in FIG. 4B, the music application is activated and displayed on the extended screen 401 as illustrated in FIG. 4C. Further, “display location” in FIG. 5 indicates such a setting that an area to the left of the smartphone 110 is designated as the display position of the extended screen 401. In FIGS. 4B and 4C, the extended screen 401 is displayed in the designated area, which is to the left of the smartphone 110, based on the set display location. The contents set on the screen in FIG. 5 are held in the storage unit 322 as the extended screen setting information. Further description will be given with reference to FIG. 3B.

A display mode management unit 330 manages a display mode, which refers to a single display mode for performing display only on the display 222 of the smartphone 110, or an extended screen display mode for displaying the extended screen 401.

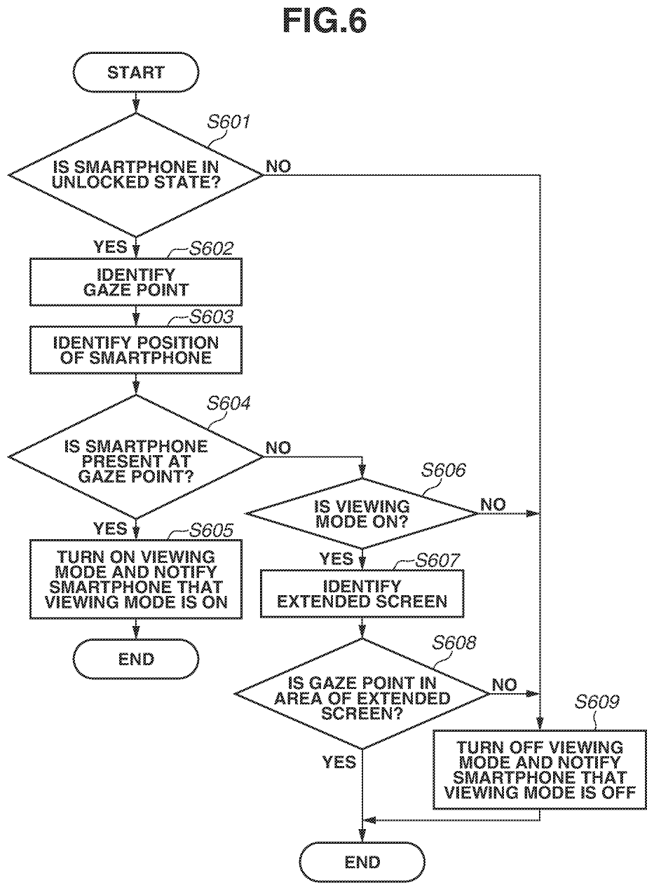

Next, processing of determining display mode transition in the glasses-type wearable terminal 101 will be described with reference to a flowchart in FIG. 6. The CPU 201 loads a program stored in the ROM 203 into the RAM 204 and executes the loaded program, so that the following processing is implemented.

FIG. 6 is the flowchart illustrating viewing mode determination processing for determining whether the user is gazing at the smartphone 110 or the extended screen 401 by AR, by the glasses-type wearable terminal 101. The user line-of-sight analysis unit 306, which is a software module executed by the CPU 201 of the glasses-type wearable terminal 101, regularly executes the flowchart in FIG. 6.

In step S601, the CPU 201 receives the state of the smartphone 110 from the connected device status management unit 309, and determines whether the state of the smartphone 110 is an unlocked state. If the state of the smartphone 110 is the unlocked state (YES in step S601), the processing proceeds to step S602. Otherwise (NO in step S601), the processing proceeds to step S609.

In step S602, the CPU 201 identifies a gaze destination of the user using the inward sensor unit 104. In identifying the gaze destination, an area (such as a red area in a heat map) where a gaze duration of the user is a specific length of time or longer is determined as a gaze point. However, the specific length of time or longer is merely an example, and the condition for the determination is not limited to this example, and may be a complex condition such as frequent gazing by the user.

In step S603, the CPU 201 identifies the position of the smartphone 110 being paired using the outward sensor unit 103. The position of the smartphone 110 is identified through the image processing and the feature recognition processing performed on the object by the image sensor of the outward sensor unit 103. The image processing and the feature recognition processing can also be performed using artificial intelligence (AI). The identification may also be performed by combining an image with information about a distance and a shape using the LiDAR sensor, or combining an image with information of the infrared sensor.

In step S604, the CPU 201 determines whether the smartphone 110 whose position is identified in step S603 is present at the gaze point of the user identified in step S602. The CPU 201 may determine that the smartphone 110 is present also in a case where the position of the smartphone 110 identified in step S603 is near the gaze point identified in step S602. If the smartphone 110 is present (YES in step S604), the processing proceeds to step S605. If the smartphone 110 is not present (NO in step S604), the processing proceeds to step S606. Here, for the determination as to whether the position of the smartphone 110 is near the identified gaze point, short-range wireless communication such as Bluetooth® may be used.

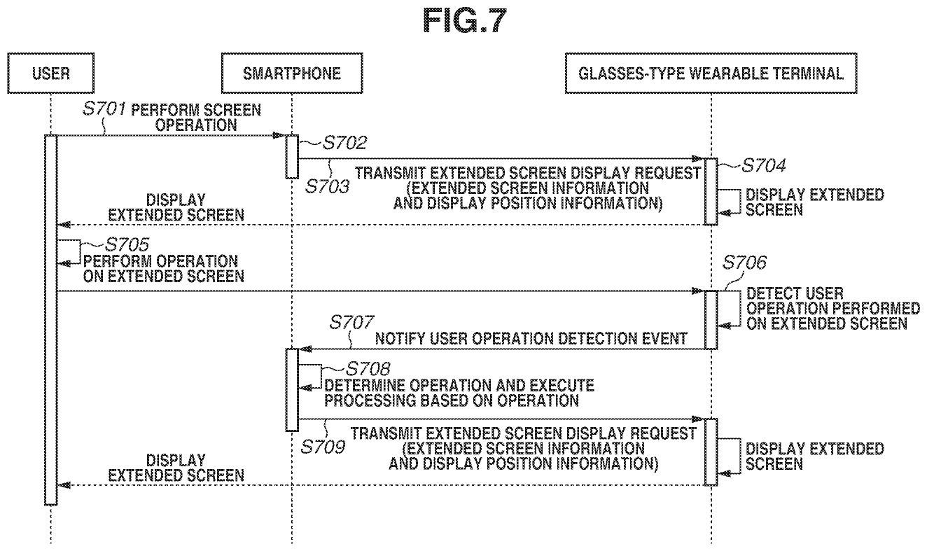

In step S605, the CPU 201 stores information indicating that a viewing mode is on in the RAM 204. Here, the viewing mode is a flag indicating whether the user is gazing at the smartphone 110, and the flag indicates that the user is gazing at the smartphone 110 in a case where the viewing mode is on, and indicates that the user is not gazing at the smartphone 110 in a case where the viewing mode is off. The viewing mode is used in a flowchart in FIG. 7. Further, the CPU 201 notifies the smartphone 110 that the viewing mode is on. Upon being notified that the viewing mode is on, the smartphone 110 brings the display mode managed by the display mode management unit 330 into the extended screen display mode.

In step S606, the CPU 201 confirms whether the information indicating that the viewing mode is on is present in the RAM 204 (the flag is on). If the information is present (the flag is on) (YES in step S606), the processing proceeds to step S607. If the information is not present (the flag is off) (NO in step S606), the processing proceeds to step S609.

In step S607, the CPU 201 identifies an area displaying the extended screen 401.

In step S608, the CPU 201 checks whether the gaze point of the user is on the extended screen 401, i.e., whether the gaze point of the user identified in step S602 is in the area of the extended screen 401 identified in step S607. If the gaze point is in the area of the extended screen 401 (YES in step S608), the viewing mode remains to be on, and the processing ends. If the gaze point is not in the area of the extended screen 401 (NO in step S608), the processing proceeds to step S609.

In step S609, the CPU 201 stores information indicating that the viewing mode is off in the RAM 204.

Further, the CPU 201 notifies the smartphone 110 that the viewing mode is off.

Upon being notified that the viewing mode is off, the smartphone 110 brings the display mode managed by the display mode management unit 330 into the single display mode.

The CPU 201 executes the processing of the flowchart in FIG. 6, thereby determining whether the user wearing the glasses-type wearable terminal 101 is gazing at the smartphone 110 or the extended screen 401. Subsequently, the CPU 201 can turn on the viewing mode in a case where the user is gazing at the smartphone 110, keep the viewing mode turned on in a case where the user is gazing at the extended screen 401, and turn off the viewing mode in a case where the user is gazing at neither the smartphone 110 nor the extended screen 401. Further, the CPU 201 can notify the smartphone 110 of the information about the viewing mode and switch the display mode between the single display mode and the extended screen display mode in cooperation with the smartphone 110. Thus, the extended screen 401 can be displayed when the user is gazing at the smartphone 110 or the extended screen 401, and the extended screen 401 can be closed when the user is gazing at neither the smartphone 110 nor the extended screen 401. In the present exemplary embodiment, the extended screen 401 is described not to be displayed when the user is gazing at neither the smartphone 110 nor the extended screen 401, but this is merely an example, and the extended screen 401 may be displayed again when the user gazes again within a predetermined time.

Here, if the user is determined to be gazing at the smartphone 110, the viewing mode is turned on and the extended screen 401 is displayed. However, the trigger for displaying the extended screen 401 is not limited thereto. For example, the extended screen 401 may be displayed when a gesture of waving the smartphone 110 toward the glasses-type wearable terminal 101 by the user is detected. Alternatively, the extended screen 401 may be displayed by the user making a predetermined gesture on the display 222 of the smartphone 110.

FIG. 7 is a sequence diagram in a case where the viewing mode is determined to be on by the flowchart in FIG. 6, and subsequently, a request to display the extended screen 401 on the glasses-type wearable terminal 101 or a user operation on the extended screen 401 is detected. The CPU 221 of the smartphone 110 executes a program stored in the ROM 223 or the like, thereby implementing processing of the smartphone 110 in FIG. 7. The CPU 201 of the glasses-type wearable terminal 101 executes a program stored in the ROM 203 or the like, thereby implementing processing of the glasses-type wearable terminal 101.

In step S701, the user performs a screen operation on the operation unit 227 of the smartphone 110. For example, an operation for displaying the home screen and an operation for activating an application each correspond to the screen operation.

In step S702, the smartphone 110 determines whether the operation performed by the user is to be displayed on the display 222 of the smartphone 110 or on the extended screen 401.

Here, the determination processing will be described with reference to a flowchart in FIG. 8.

FIG. 8 is a flowchart of the processing executed by the CPU 221 of the smartphone 110 when a screen operation is performed by the user or a notification event such as reception of an email is received.

In step S801, the CPU 221 acquires the display mode from the display mode management unit 330 and confirms whether the acquired display mode is the extended screen display mode. If the acquired display mode is the extended screen display mode (YES in step S801), the processing proceeds to step S802. Otherwise (NO in step S801), the processing proceeds to step S806.

In step S802, the CPU 221 acquires an extended screen display setting from the extended screen display setting management unit 329.

In step S803, the CPU 221 determines whether to display the extended screen information on the extended screen 401 (whether to display the extended screen 401) based on the extended screen display setting acquired in step S802. For example, in a case where the user performs an operation for displaying the home screen, the CPU 221 determines to display the extended screen 401 if displaying the home screen is set in the display setting for the extended screen in FIG. 5. If the CPU 221 determines to display the extended screen 401 (YES in step S803), the processing proceeds to step S804. Otherwise (NO in step S803), the processing proceeds to step S806.

In step S804, the CPU 221 generates the extended screen information to be displayed as the extended screen 401 that can be operated. For example, in a case where the extended screen display setting is the setting illustrated in FIG. 5, the CPU 221 generates the extended screen 401 (FIG. 4B) displaying an icon for an application that cannot be displayed on the display 222 of the smartphone 110 in a case where the user performs an operation for displaying the home screen. Further, the CPU 221 generates the extended screen 401 (FIG. 4C) displaying a screen for the music application in a case where the user activates the music application. A screen for the music application similar to the screen illustrated in FIG. 4C may be displayed on the display 222 as with the home screen, and the extended screen 401 for displaying a screen related to display of the display 222 (such as a screen for changing the sound quality) may be generated.

In step S805, the CPU 221 transmits the extended screen information generated in step S804 and the display position information of the extended screen display setting acquired in step S802 to the glasses-type wearable terminal 101 via the extended screen display request unit 326.

In step S806, the CPU 221 displays a screen indicating the result of the operation performed by the user on the display 222 of the smartphone 110.

Executing the above-described processing in the flowchart in FIG. 8 makes it possible to determine whether the result of receiving a user operation or an event such as a notification is to be displayed on the display 222 of the smartphone 110 or on the extended screen 401. Further, in a case where the extended screen that can be operated is to be displayed, the display information of the extended screen to be displayed on the glasses-type wearable terminal 101 can be transmitted as the extended screen display request.

The sequence diagram in FIG. 7 will be further described below.

In step S703, the smartphone 110 transmits the extended screen display request, which is the display information of the extended screen, to the glasses-type wearable terminal 101, in step S805 described above.

In step S704, the glasses-type wearable terminal 101 receives the extended screen display request from the smartphone 110 via the extended screen display request receiving unit 307.

Processing executed by the CPU 201 of the glasses-type wearable terminal 101 when the extended screen display request is received by the extended screen display request receiving unit 307 of the glasses-type wearable terminal 101 in step S704 will be described with reference to a flowchart in FIG. 10.

In step S1001, the CPU 201 receives the extended screen display request. The extended screen display request includes the extended screen information and the display position information.

In step S1002, the CPU 201 identifies the position of the smartphone 110 being paired using the outward sensor unit 103. The position of the smartphone 110 is identified through the image processing and the feature recognition processing performed on the object by the image sensor of the outward sensor unit 103. As with step S603 described above, the processing for identifying the position may also be performed by adding the distance information of the LiDAR senor and the information of the infrared sensor, or AI may be utilized for the image processing and the like.

In step S1003, the CPU 201 identifies the display position of the extended screen 401 based on the display position information included in the extended screen display request received in step S1001 and the position of the smartphone 110 identified in step S1002.

In a case where the display position information is left, the CPU 201 identifies the area to the left of the position of the smartphone 110 as the position where the extended screen 401 can be displayed.

In step S1004, the CPU 201 displays the extended screen information included in the received extended screen display request, at the position identified in step S1003, on the display unit 102 of the glasses-type wearable terminal 101.

Executing the above-described flowchart in FIG. 10 enables the glasses-type wearable terminal 101 to display the extended screen on the display unit 102 based on the extended screen information and the display position information included in the received extended screen display request.

The sequence diagram in FIG. 7 will be further described below.

Subsequently, in step S705, the user performs an operation on the extended screen 401 displayed in step S704. The operation on the extended screen 401 refers to, for example, making a gesture as if touching the extended screen 401.

In step S706, the glasses-type wearable terminal 101 detects the operation performed by the user via the outward sensor unit 103. The operation of the user performed on the extended screen 401 may be an operation using the line of sight and a blink of the user. In this case, the user operation detection unit 308 of the glasses-type wearable terminal 101 detects the line of sight and the blink of the user wearing the glasses-type wearable terminal 101 using the inward sensor unit 104, thereby detecting the operation performed on the extended screen 401. This enables the user to perform the operation on the extended screen 401 even if the user is doing some work with hands or the user has physically disabled hands.

Subsequently, in step S707, in a case where the operation is determined to be performed on the extended screen 401, the glasses-type wearable terminal 101 notifies the smartphone 110 of a user operation detection event including the position information within the extended screen 401 of the operation performed by the user.

In step S708, the smartphone 110 receives the user operation detection event. Upon receiving the user operation detection event, the smartphone 110 determines the operation performed on the extended screen 401 and executes processing based on the operation.

The processing executed by the smartphone 110 based on the operation performed on the extended screen 401 will be described below with reference to a flowchart in FIG. 9.

The flowchart in FIG. 9 represents processing executed when the user operation detection event is received by the smartphone 110. The CPU 221 loads a program stored in the ROM 223 into the RAM 224, and executes the loaded program, thereby implementing the following processing.

In step S901, the CPU 221 receives the user operation detection event via the communication unit 321.

In step S902, the CPU 221 acquires the position information about the operation performed by the user within the extended screen 401 from the user operation detection event received in step S901.

In step S903, the CPU 221 determines the performed operation based on the position information about the operation performed by the user within the extended screen 401, acquired in step S902. For example, in a case where a tap operation is performed at the position of the icon for the music application displayed on the extended screen 401 as illustrated in FIG. 4B, the CPU 221 determines that the tap operation is an operation for activating the music application.

In step S904, the CPU 221 executes processing based on the operation determined in step S903.

In step S905, the CPU 221 executes screen display processing relating to the processing executed in step S904. The screen display processing is the processing according to the flowchart described with reference to FIG. 8.

The user operation detected by the glasses-type wearable terminal 101 can be executed by the smartphone 110, and the result of the execution can be reflected in the display 222 of the smartphone 110 or the extended screen 401, by performing the above-described processing of the flowchart in FIG. 9. The sequence diagram in FIG. 7 will be further described below.

In step S709, the smartphone 110 transmits the extended screen display request to the glasses-type wearable terminal 101 in order to update the contents of the extended screen 401.

For example, in the case where a tap operation is performed at the position of the icon for the music application displayed on the extended screen 401 as illustrated in FIG. 4B, the smartphone 110 transmits the extended screen display request to display the music application on the extended screen 401 as illustrated in FIG. 4C.

Performing the above-described processing in the sequence diagram illustrated in FIG. 7 makes it possible to display the extended screen 401 on the display unit 102 of the glasses-type wearable terminal 101. Moreover, it is possible to detect an operation performed on the extended screen 401, notify the smartphone 110 of the detection, and re-render the screen on the display 222 of the smartphone 110 or the extended screen 401.

The above-described processing is performed so that information exceeding the screen size of the smartphone 110 can be displayed for the user by using the extended screen 401 by AR. Further, an operation performed on the extended screen 401 can be detected, and processing corresponding to the detected operation can be executed, and further, the result can be reflected in the screen of the smartphone 110 or the extended screen 401.

In the first exemplary embodiment, the user makes the gesture as if touching or the like as the user operation on the extended screen 401, and the gesture is detected using the outward sensor unit 103, as described in step S705 and step S706. In the method of detecting a gesture as in the first exemplary embodiment, the screen displayed on a smartphone 110 is operated by physically operating a touch panel display of the smartphone 110, while the extended screen 401 is operated by performing an operation in an empty space, and thus operability vary.

A second exemplary embodiment is intended to provide uniformity to the above-described operability.

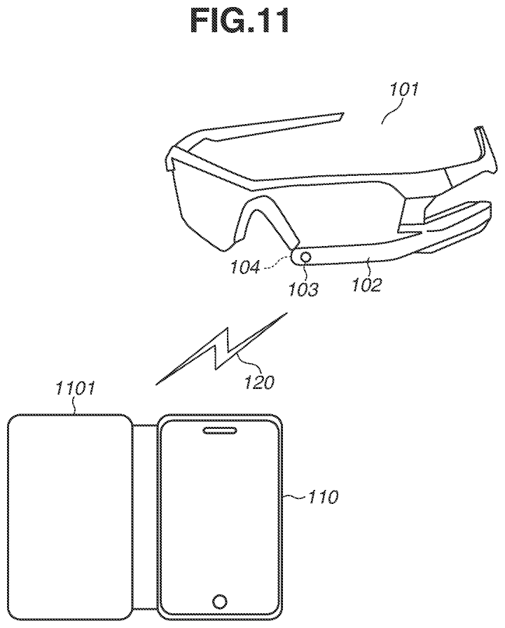

FIG. 11 is an overview diagram illustrating a connection relationship between the glasses-type wearable terminal 101 and the smartphone 110 according to the second exemplary embodiment.

A high heat sensitivity material is used for an AR accessory 1101. In this example, a notebook-type smartphone case is used, but this is merely an example, and the present exemplary embodiment is not limited thereto.

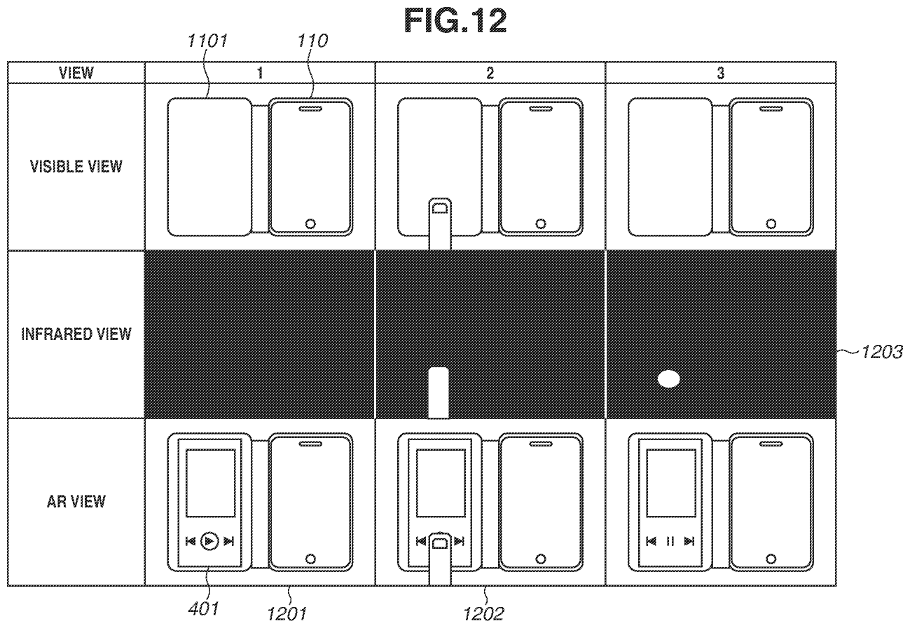

FIG. 12 is a diagram illustrating a method of identifying a part touched by the user by utilizing an infrared screen using the outward sensor unit 103.

A visible view is a view in the real world, an infrared view is a view on the infrared screen using the outward sensor unit 103, and an AR view is a view displayed via the display unit 102 of the glasses-type wearable terminal 101.

An AR view 1 (a section 1201) is an example in which the extended screen 401 that can be operated is displayed to fit on the AR accessory 1101. In this example, the music application is displayed on the extended screen 401.

In a case where the user wants to operate the extended screen 401, the user performs a touch operation on the AR accessory 1101 as illustrated in an AR view 2 (a section 1202). In a case where such an operation is performed, the part touched by the user is evident as illustrated in an infrared view 3 (a section 1203).

The glasses-type wearable terminal 101 identifies the position information about the operation performed by the user within the extended screen 401 in the infrared view 3 (the section 1203), and transmits the identified position information to the smartphone 110 in step S707 in FIG. 7, so that a place where the touch operation is actually performed by the user is notified.

The user operation performed on the AR accessory 1101 having high heat sensitivity is detected by the glasses-type wearable terminal 101 by performing the above-described processing, so that the user can physically operate the extended screen 401. Therefore, the user can physically operate both the display 222 of the smartphone 110 and the extended screen 401, so that the uniform operability can be obtained.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2021-082213, filed May 14, 2021, which is hereby incorporated by reference herein in its entirety.

What is claimed is:

1. An information terminal system comprising a mobile terminal having a display and a glasses-type wearable terminal being communicably connected to each other,
the glasses-type wearable terminal comprising:
at least one processor and at least a memory having instructions stored thereon, and when executed by the at least one processor, acting as:
a display unit configured to display an operable extended screen by projecting the extended screen in part of a view of a user wearing the glasses-type wearable terminal based on display information of the extended screen received from the mobile terminal;
a first detection unit configured to detect a user operation on the extended screen; and
a first transmission unit configured to transmit information indicating the user operation detected by the first detection unit to the mobile terminal,
the mobile terminal comprising:
at least one processor and at least a memory having instructions stored thereon, and when executed by the at least one processor, acting as:
a second transmission unit configured to transmit the display information of the extended screen to the glasses-type wearable terminal; and
a processing unit configured to execute processing corresponding to the user operation based on the information indicating the user operation transmitted by the first transmission unit.

2. The system according to claim 1, wherein the at least one processor of the mobile terminal is further configured to transmit the display information of the extended screen that reflects a result of the processing corresponding to the user operation executed by the processing unit to the glasses-type wearable terminal.

3. The system according to claim 1, wherein the at least one processor of the glasses-type wearable terminal is further configured to project the extended screen at a position based on a position of the display of the mobile terminal in the view of the user.

4. The system according to claim 3,
wherein the display information of the extended screen includes extended screen information and display position information designating a position to display the extended screen, and
wherein the at least one processor of the glasses-type wearable terminal is further configured to project the extended screen at a position corresponding to the display position information based on the position of the display of the mobile terminal in the view of the user.

5. The system according to claim 3, wherein the at least one processor of the glasses-type wearable terminal is further configured to project the extended screen at a position adjacent to the display of the mobile terminal in the view of the user.

6. The system according to claim 1, wherein the first detection unit includes an image sensor and detects a predetermined gesture on the extended screen as the user operation using the image sensor.

7. The system according to claim 1, wherein the first detection unit includes a LiDAR sensor and detects a predetermined gesture on the extended screen as the user operation using the LiDAR sensor.

8. The system according to claim 1, wherein the at least one processor of the glasses-type wearable terminal further acts as:
a second detection unit configured to detect a line of sight of the user; and
a determination unit configured to determine that the user is gazing at the mobile terminal based on a position of the mobile terminal and the line of sight of the user detected by the second detection unit.

9. The system according to claim 1,
wherein the at least one processor of the glasses-type wearable terminal further acts as a third transmission unit configured to transmit information indicating that the user is gazing at the mobile terminal, and
wherein, in a case where the user is gazing at the mobile terminal and a predetermined operation is performed, the mobile terminal generates the display information of the extended screen, and the second transmission unit transmits the generated display information of the extended screen to the glasses-type wearable terminal.

10. The system according to claim 1,
wherein the mobile terminal further comprises an accessory using a high heat sensitivity material,
wherein the extended screen is displayed on the accessory,
wherein the first detection unit of the glasses-type wearable terminal includes an infrared sensor, and
wherein the first detection unit detects an operation on the accessory performed by the user using the infrared sensor.

11. A method for a mobile terminal having a display and a glasses-type wearable terminal, the method comprising:
transmitting display information of an extended screen from the mobile terminal to the glasses-type wearable terminal;
displaying the extended screen by projecting the extended screen in part of a view of a user wearing the glasses-type wearable terminal based on the display information of the extended screen received from the mobile terminal, by the glasses-type wearable terminal;
detecting a user operation on the extended screen, by the glasses-type wearable terminal;
transmitting information indicating the detected user operation to the mobile terminal, by the glasses-type wearable terminal; and
executing processing corresponding to the user operation based on the information indicating the transmitted user operation, by the glasses-type wearable terminal.

12. A non-transitory computer-readable storage medium storing a program to cause a computer to perform a method for a mobile terminal having a display and a glasses-type wearable terminal, the method comprising:
transmitting display information of an extended screen from the mobile terminal to the glasses-type wearable terminal;
displaying the extended screen by projecting the extended screen in part of a view of a user wearing the glasses-type wearable terminal based on the display information of the extended screen received from the mobile terminal, by the glasses-type wearable terminal;
detecting a user operation on the extended screen, by the glasses-type wearable terminal;
transmitting information indicating the detected user operation to the mobile terminal, by the glasses-type wearable terminal; and
executing processing corresponding to the user operation based on the information indicating the transmitted user operation, by the glasses-type wearable terminal.
